(19) United States
(12) Patent Application Publication
(10) Pub. No.: US 2011/0161058 A1
(43) Pub. Date: Jun. 30, 2011

(54) METHOD, SYSTEM, APPARATUS AND COMPUTER PROGRAM FOR CREATING A PROSTHESIS SOCKET

(76) Inventor: Bernd Schottdorf, Dischingen (DE)

(21) Appl. No.: 13/054,392

(22) PCT Filed: Jul. 8, 2009
(86) PCT No.: PCT/EP2009/004968

§ 371 Date: Mar. 21, 2011

(30) Foreign Application Priority Data
Jul. 8, 2008 (DE) 10 2008 032 992.4

(51) Int. Cl. G06F 17/50

(52) U.S. Cl. 703/1

(57) ABSTRACT

An apparatus, system, method and computer program for a user (1102) to interact (1110) with a 3D socket/stump computer model (190; 401; 500; 600) to modify the 3D socket/stump computer model (190; 401; 500; 600) which describes the surface shape and spatial tissue distribution of a stump, which are designed to subdivide the 3D socket/stump computer model (190; 401; 500; 600) into sections (301; 700; 900; 1106), to display the surface shape and tissue distribution in one section (301; 700; 900; 1106) of the 3D socket/stump computer model (190; 401; 500; 600) on a display (1100), to allow the user to select by means of a first selection module a section (301; 700; 900; 1106) of the 3D socket/stump computer model (190; 401; 500; 600) for display on the display (1100), to allow the user to select by means of a second selection module at least one predefined spatial distribution of a modification of the surface shape in the section (301; 700; 900; 1106), and to modify the surface shape in the section (301; 700; 900; 1106) according to the selected spatial distribution.

### FIELD OF THE INVENTION

The present invention relates to a method, a system, an apparatus and a computer program for creating and modifying a 3D socket/stump model for producing a prosthesis socket for connecting a body part forming a stump to a prosthesis.

### BACKGROUND OF THE INVENTION

Until now prostheses for amputees, particularly below-knee and above-knee prostheses, were crafted manually in that an orthopedic technician formed a negative plaster cast of the patient's stump. By manually sensing (palpating) the stump, the orthopedic specialist and/or the orthopedic technician determines additional anatomical information which is incorporated into a manual post-processing of a positive model of a stump created from the piaster negative. The positive model of the stump post processed by the orthopedic technician serves as a starting base for the production of a rigid or flexible socket depending on the material used, for example thermoplastics, casting resins and wood. For visual inspection of pressure points, typically a thermoplastic transparent socket is deep drawn over the positive model of the stump. Durable sockets composed of a transparent socket are deep drawn over the positive model of the stump. Durable sockets composed of casting resin are reinforced by the orthopedic mechanic using implanted meshworks, for example carbon Kevlar mesh, carbon fibers or glass fiber mesh. Until now, the objective was to produce a socket that fits as optimally as possible on the stump, and that prevents excessive pressure and rubbing against the stump, but also offers a good hold and wearing comfort. This goal however is routinely not attained so that multiple so-called sample sockets of different volume, e.g. a thermoplastic transparent socket, must be produced before a durable so-called definitive socket can be comfortably used by the patient.

The objective of the dissertation by M. Hasenpusch, entitled “Beitrag zur Optimierung der Stumfdatenerfassung und computergestützen Stumpbettgestaltung” [Contribution to the Optimization of Capturing Stump Data and Computer Aided Stump Bed Formation”] was to create a socket starting from a loaded and unloaded patient stump using computer aided modeling. Hasenpusch describes using CAD/CAM systems for computer aided socket design (CASD).

Hasenpusch's dissertation presents among others the so-called San Antonio system of the University of Texas, San Antonio. The system to produce below-knee stump beds using a digitizer, laser scanner, ultrasound, computer tomography (CT) and magnetic resonance tomography (MRT). Digitally captured data of the stump is converted by the San Antonio system into a topographical surface and represented as a lattice model. The system can represent a complete 3D image of cross-sectional layers. When the San Antonio system processes CT images, then only modifications to cross-sectional contours are possible. If laser data and digitizer data are processed, the system can then perform cross-sectional modeling, profile modeling and modifications to the 3D lattice model. The socket is manufactured using a 3-axis CNC milling machine.

Hasenpusch's dissertation further refers to the additional capturing of the bone structure by CT, MRT and ultrasound for instances in which the orthopedic technician manually customizes a model on the computer without having previously produced a plaster cast. As a research goal, Hasenpusch moreover describes obtaining a geometric description of the outer contour as well as the bone contour of a stump, using CT and MRT as imaging methods.

The unexamined patent application DE 10 2005 008 605 from Gottinger Orthopädie-Technik GmbH describes a method for producing an external prosthesis or orthotic using these steps: creating a tomography of the affected body part; converting the created data into a 3D model; evaluating the bone, muscle and fatty tissue structure; determining compression zones depending on the evaluation and creation of a prosthesis/orthotic element depending on this data.

DE 10 2005 008 605 from Gottinger Orthopädie-Technik GmbH describes the use of CT or MRT images of an above-knee stump and CAD software for creating a 3D model and possibly its modulation of previously created specific forms. The musculature and fatty tissue are visible in the 3D model. Furthermore, the shaping of a virtually created prosthesis socket can be optimized using the computer.

A further publication, EP 1 843 291 A1, of Gottinger Orthopädie-Technik GmbH describes an objectified method for creating a prosthesis socket for an extremity stump of a patient that, during the creation of a continuous three dimensional model, considers information about the position of muscle tissue, fat tissue and bone tissue in the stump, that determines a target compression on the basis of the weight of the patient and the outer surface of the stump, and that considers the compressibility of the portions of muscle tissue and fatty tissue.

The object of the present invention is to provide an improved method that in particular considers more strongly the actual tissues structure of the stump, a system, apparatus and computer program for creating a prosthesis socket with which prosthesis sockets can be manufactured adapted to the stump.

### SUMMARY OF THE INVENTION

According to the invention, this objective is solved by a method, an apparatus, a system and a computer program according to the independent claims. Variants and preferred embodiments of the invention arise from the dependent claims, the following description and the drawings.

One aspect of the invention relates to a method for creating a 3D socket/stump model for producing a prosthesis socket for connecting a body part forming a stump to a prosthesis, having the following steps. As a first step, three-dimensional (3D) image data of the body part forming the stump comprising the multiple tissue types such as skin, fat, muscle and bone, are acquired. Computer tomography (CI) or magnetic resonance tomography (MRT) advantageously produces high resolution tomography of the body part forming the stump at predetermined layer distances and predetermined layer thicknesses, wherein a plurality of serially acquired tomographies can farm 3D image data in the form of volumetric data. The use of magnetic resonance tomography (MRT) instead of CT has the advantage of reducing (x-ray) radiation exposure for the patient. For supplementing the CT and/or MRT, conventional x-rays, sonograms, optoelectronic recordings or other imaging methods can be used. The combination of CT and/or MRT and/or x-ray and/or sonography advantageously produces more exact 3D image data about the inner and outer condition of the stump.

A storage medium, for instance CD/DVD, hard disk, USB stick or the like can store the acquired 3D image data that are present in a predetermined format. Such a storage medium is advantageous in that the 3D image data can be archived and transported rapidly. In addition, the 3D image data can be acquired at a first remote location that lies spatially distant from a second central location at which subsequent postprocessing steps can be performed on the 3D image data.

Furthermore, the 3D image data can be transferred from the first location to the second location, for instance via the Internet or similar. The advantage of this is the spatial separation of the first location at which, for example, a CT device acquires the 3D image data, and the second location at which the further postprocessing steps can be performed.

Preferably, the DICOM standard (Digital Imaging and Communications in Medicine) is used. The standard can specify both a first storage format of the 3D image data as well as its communication.

Preferably, after the storage and/or transmission of the 3D image data, a conversion method is applied to the 3D image data. The resulting 3D image data can be stored in a second storage format and/or transmitted further. The conversion method can be performed for instance by a conversion unit which is located at the second central location. The conversion unit preferably comprises a server, processor, DSP chip or similar. The other storage format comprises, for instance JPEG, GIF, TIFF, BMP, PDF or similar.

The 3D image data which contain information about the stump condition are preferably subjected in a further step of the method to segmentation which serves to determine the distribution of tissue types of the stump. The segmentation produces an assignment of the pixels to different tissue types, and with it, a distinction of the tissue types, wherein the tissue types comprise skin, fat, muscle and bone, etc. The segmentation can preferably subdivide more exactly into further tissue types using threshold values, for example gray scale values, wherein the tissue types have a spatial distribution that is to be determined. Properties such as compressibility, density, strength, sensation of pain and/or pain sensitivity, etc. can be assigned to the tissue types.

The segmented 3D image data are preferably reconstructed in a further step of the method into a 3D socket/stump model. This reconstruction is a procedure that converts consecutive two-dimensional tomographies of the segmented 3D image data of the stump, for example by interpolation, into a 3D socket/stump model. The 3D socket/stump model describes the geometry of the stump and the distribution at least of one segmented tissue type of the stump. Also, the actual volume of the stamp is represented by the 3D socket/stump model. Thus, the 3D socket/stump model corresponds to an exact reproduction of the stump with the exception of possible errors in the imaging method, for instance measurement inaccuracies, interpolation and rounding errors.

Advantageously, the above mentioned processes, segmentation of the 3D image data and reconstruction of the 3D socket/stump model, which follow the first step of acquiring the 3D image data, can be performed automatically without the patient and without an orthopedic technician.

In a further step of the method, at least one stump axis is determined in the 3D socket/stump model. This can be performed, for example, manually by the user or completely automatically. The spatial location of the stump axis is preferably specified by an upper and a lower stump axis point. For example, the stump axis proceeds along a force action direction, which can occur at the body parts forming the stump. Thus, the stump axis of the 3D socket/stump model can proceed through the femur (upper thigh bone), or can be defined by the articulatio coxae (hip joint) and the articulatio genus (knee joint) according to the biomechanics and/or motor function. Alternatively, the upper stump axis point can preferably lie at the fossa acetabuii. The lower stump axis point can alternatively be defined at a distal area of the stump by a geometric averaging. Two further axes can be specified orthogonally to the stump axis to preferably allow the definition of three-dimensional spatial directions and dimensions.

The method comprises the further steps: subdivision of at least one area of the 3D socket/stump model into at least one slice of a specific thickness or one layer at a specific distance essentially perpendicular to the stump axis, and subdivision of at least one slice or layer in angular sectors. Alternatively, at least one slice or layer can be specified essentially perpendicular to the femur in the 3D socket/stump model. In this case, at least one slice is subdivided into a predetermined number of angular sectors of equal and/or different angular portions. The angular sectors in the slice form a complete circle, wherein the sum of the angular portions amounts to 360°. Preferably, the at least one slice is subdivided into at least two angular sectors. For example, a much more precise lit can be created with a 3D socket/stump model by using a higher number of angular sectors.

In a further step of the method, the 3D socket model is modified on the basis of knowledge-based rule sets for optimally adapting the 3D socket/stump model to the stump, wherein the knowledge-based rule sets can be applied to at least one angular sector of the at least one slice or layer. The knowledge-based rule sets consider the information contained in the 3D socket/stump model about the geometry of the stump and/or the distribution of at least one type of tissue. In addition, knowledge-based rules comprise at least one or more rules which use one or more properties of at least one segmented tissue type. Properties of at least one segmented tissue type are preferably physical variables and physiological properties, for example density, compressibility, strength and sensation of pain, or a value or factor that indicates the volume compression.

The stump axis can also be determined automatically based on the knowledge-based rule sets. Preferably, the method is applied to create a 3D socket/stump model for producing a prosthesis socket for connecting a body part forming a stump to a prosthesis.

During the acquisition of the 3D image data of the body part forming the stump, a so-called liner is preferably applied to the stump. This forces a desired shape of the stump during image acquisition in order to counteract an artificial lateral shaping of the stump, for example. Ideally, the desired shape corresponds to the shape of the stump in the state when the patient is standing upright in which the force of gravity acts along the longitudinal axis of the body. Furthermore, the selection of the material that comprises the liner can be suited for segmentation, that is, the material advantageously has a high or low density to allow tissue types of the stump in the 3D image data to be distinguished from the surrounding tissue types that do not belong to the stump. The liner preferably comprises silicone, polyurethane (PU) or similar material.

The 3D image data can be acquired while a patient lies on the side of his body-opposite the stump, wherein his leg opposite the stump is bent. The bending advantageously causes a relaxed position of the pelvis and a correct flexed position of the stump.

According to a further example embodiment, the segmentation of the 3D image data comprises a segmentation based on 2D representations of the 3D image data. The 2D representations can be two-dimensional sectional images, which correspond to, or are similar to, the tomographies of the imaging method, based on the 2D tomographies using sectional images determined by an interpolation method. Preferably the two-dimensional representations can be sectional images which are disposed perpendicular to the stump axis defined on the basis of medical criteria.

According to a further example embodiment, the segmentation of the 3D image data comprises a detection of the contour and/or a vectorization. In the contour detection, preferably individual layer images from the 3D data are analyzed based on their color values. Because different tissue types each have similar color values, they can thereby be preferably delimited and/or differentiated from each other. The vectorization of 3D image data creates a geometry from separated pixels which has mathematically defined areas and/or curves.

For reconstructing a 3D socket/stump model, preferably segmented 3D image data are used, i.e., image data that are vectorized and provided with contours. The reconstruction produces a 3D socket/stump model that replicates a body part forming a stump. Using a suitable display method or a display program for the reconstructed 3D socket/stump model, a front view of the model or a top view of different two-dimensional image sections through the 3D socket/stump model, for example, can be shown to the user. Based on the representation of the model, preferably a defective position of the stump can be determined by the orthopedic technician or the physician. For this purpose, a defective position triangle can be constructed based on anatomical structures clearly derivable from the two-dimensional sectional images (for example, bone structures in the pelvic region) which indicate a measure of an outer rotation of the stump to the body axis of the patient. Preferably, a defective position triangle can be determined automatically.

A reconstruction unit for reconstruction can be disposed at the second central location, and can be designed for reconstructing and/or storing and/or further transmitting the 3D socket/stump model. The 3D socket/stump model can be stored in a predetermined third storage format. The 3D socket/stump model can advantageously comprise tissue types and size information of the body part forming the stump.

The knowledge-based rule sets preferably modify the 3D socket/stump model so that the modification results in improved force transfer between the stump and the prosthesis socket.

The use of knowledge-based rule sets for modifying a 3D socket/stump model preferably comprises values based on experience, e.g., empirical values for the physical, physiological and anatomical properties of specific tissue areas determined from series of measurements of test persons with sockets, in the form of at least one mathematical transformation. The modification of the 3D socket/stump model based on such knowledge-based rule sets preferably leads to a change in volume or shape of the 3D socket/stump model.

For at least one of the different tissue types, the knowledge-based rule sets can comprise at least one of the following tissue properties as a tissue parameter: sensation of pain, strength, density and compressibility, or a value or factor which indicates the volume compression.

Further, the knowledge-based rule sets can also comprise at least one of the parameters patient body weight and stump outer surface, wherein the stump outer surface can be determined automatically using an area calculation based on the 3D socket/stump model. In order to further increase the wearing comfort of the socket to be created, it can be advantageous to determine a socket modification to be attained by modifying the 3D socket/stump model based on the parameters of body weight and stump outer surface. Preferably the modification is a volume change or compression. A volume compression to be attained can be translated into a pressure distribution over the entire 3D socket/stump model by means of a proportionality factor, for example the compressibility of a specific tissue type or several tissue types. The compressibility is a physical variable k which describes a relative volume change as a result of a pressure change. For determining a pressure distribution, it can be particularly advantageous to also consider the position of bone structures or the start of the femur in the distal region of the 3D socket/stump model, along with the compressibility of different tissue types. Thus, preferably no modification of the 3D socket/stump model is made in the distal area below the femur, for example.

According to a further embodiment of the invention, the previously determined angular sector subdivisions, from which the user can select the slice, depend on the position of the slice or layer within the stump, the tissue distribution in the slice and/or physiological and anatomical properties of the stump or the patient. The previously determined spatial distributions are preferably determined or adapted by the user or automatically. For an automatic adaptation, the knowledge-based rule sets preferably undergo a self-learning process. It is advantageous if the knowledge-based rules can be completely or partially automated by certain self-learning methods or similar. Preferably knowledge-based rules are self-learning in that information about the geometry and/or distribution of the at least one segmented tissue type, contained in one or more stumps from different patients, is stored and analyzed. The knowledge-based rules can evaluate, for example, which angular sector subdivision was used particularly frequently during modification of a 3D socket/stump model in a specific section, and perform an ordering of the angular sector subdivisions according to their significance. Corresponding to this ordering, proposals for angular sector division can be made to a user. Furthermore, the self-learning can also relate to the assignment of the compression factors to the individual angular sectors. The most frequently used compression factor, together with an angular sector subdivision, can be proposed to the user for a preferred selection. The self-learning process always considers the tissue distribution present in an area of the 3D socket/stump model. Furthermore, the knowledge-based rule sets can also evaluate input from the user, for example a selection of a compression factor, to be used during Its self-learning process. Thus, the procedure can be optimized and the socket can be better adapted to the patient's stump from patient to patient as their 3D socket/stump model is modified using the described method.

According to a further embodiment of the invention, the previously determined subdivisions of the angular selection from which the user can select for a slice take into account an expected physiological change to the stump. Using feedback, i.e. by evaluating required local or global volume changes in the 3D socket/stump model of the same patient over time, the manufacture of a subsequently improved prosthesis socket can be simplified and improved. The feedback from so-called longitudinal studies or longitudinal section studies about the change of the patient's stump can, for example, be performed by optical scanning and/or capturing a prosthesis socket by some other means. The determined deviations to the modified 3D socket/stump computer model can be evaluated automatically by the knowledge-based rule sets, and can be adapted by a new modification of the 3D socket/stump model. Preferably a modular prosthesis socket can be provided which can be easily changed subsequently by addition, removal, or shifting of prosthesis socket subcomponents, for example inlay pieces, spacers, elastic mats, support elements or the like, on or in the prosthesis socket without having to create a new socket.

Furthermore, over the course of time while wearing a prosthesis socket, typical changes in tissue or tissue volume, for example, can occur in the body part forming a stump. Therefore, it can be advantageous if the self-learning knowledge-based rules can predict a 3D socket/stump model taking into account the typical changes in tissue or tissue volume. For this purpose, the typical changes of stumps of different patients over time are determined and evaluated In longitudinal studies. Statistically significant average volume changes can then be automatically considered by the knowledge-based rule sets during the modification of a 3D socket/stump model. By taking into account a typical predicted tissue change, a socket can be created according to the invention which can be worn by the patient longer than is typical because it has a fit which takes into account the future changes of the stump. As a result, the wearing time of a stump can be extended. Also, the amount of treatment of a prosthesis patient can be reduced, and the patient's quality of life can be increased by fewer visits to the physician.

According to a further example embodiment, the method can comprise determining a reference plane perpendicular to the stump axis. For this, the reference plane cuts a uniquely specified anatomic point, preferably at a distal location of the ischium (os ischii) of the 3D socket/stump model. The reference plane can serve for determining a further plane—also called a zero section—at a predetermined offset to the reference plane and parallel to the reference plane. The further plane is preferably determined at a distance of 5 cm, for example, to the distal end of the stump.

According to a further example embodiment, the further plane can be used to divide the stump into a proximal and distal section. The determination of the reference plane and also the further plane (zero section) and the resulting division of the 3D socket/model into proximal and distal sections, can be completely automatic.

According to a further embodiment of the method according to the invention, the modification comprises a volume compression, wherein the knowledge-based rule sets comprises at least one factor for volume compression. Preferably the 3D socket/stump model is modified, distorted and/or skewed by means of compression factors. For example, a slice or a layer, an area, an angular sector or similar can be modified, distorted and/or skewed. A volume compression factor is preferably a specific compression value for at least one of the segmented tissue types which results from the physical properties, for example the compressibility, of a segmented tissue type. The volume compression factor is preferably a percentage value relative to a tissue volume determined based on the 3D socket/stump model, or a corresponding absolute value.

According to a further embodiment of the invention, the modification comprises a volume expansion, wherein the knowledge-based rule sets comprises at least one factor for volume expansion. In this case, the volume compression factor is negative. The factor for volume change can advantageously be set and/or changed automatically or manually by a user.

According to a further example embodiment, the at least one factor for volume compression can be the compression value of the segmented fatty tissue. Because fatty tissue has a higher compressibility than muscle, skin or bone tissue, it corresponds well to the physiological conditions. Incidentally, the computational expenditure and computational time can be advantageously reduced if only the fatty tissue present in the stump is considered during modifications of the 3D socket/stump model.

According to a further aspect, at least one slice perpendicular to the stump axis is assigned to a proximal or at a distal area of the 3D socket/stump model. In the proximal area of the 3D socket/stump model, a modification is preferably performed based on volume compression factors specified as an absolute value which are applied to at least one angular sector; whereas at the distal end, a modification is performed based on percentage volume compression factors.

According to a further embodiment of the invention, the at least one slice or layer of a proximal area has a greater thickness or a greater offset than the at least one slice or layer of a distal area. Preferably the thickness of a slice can be determined to be inverse to the complexity of the tissue area and/or anatomy contained in the slice. For example, a greater slice thickness is specified if the complexity of the tissue areas contained therein is low, and vice versa. Furthermore, an advantageous greater accuracy can be attained by adapting the slice thickness or layer offset, for example in the proximal area of the 3D socket/stump model. Each slice or layer contains information about the tissue distribution in a volume element lying essentially perpendicular to the stump axis; every pixel of a two-dimensional representation of a layer or slice contains three-dimensional information.

Further, the use of proximal volume compression factors specified as an absolute value permits greater slice thicknesses or layer offsets because in the proximal area, an adaptation to the given bone structure can be advantageous. Alternatively, slices of greater thickness are specified in the distal area because the distal end of the stump up to the tip of the femur, for example, does not require any modification. The advantage of a slice thickness adapted to the stump area can be reduced effort depending on the given anatomy in the 3D socket/stump model, and the desired modification of the 3D socket/stump model.

According to a further embodiment, the at least one slice is divided into angular sectors, wherein the angular sectors are smaller medially than laterally because medially, an exact modification is necessary taking into account the tissue distribution to allow a better adaptation of the 3D socket/stump model to existing bone structures, or to be able to better guarantee strong blood circulation in the stump while contacting the created socket or during general use of the socket, for example. Generally, an advantage of a predetermined number of angular sectors with equal and/or different angular portions is a more rapid application of the knowledge-based rule sets or volume compression factors, because during the procedure, it is no longer necessary to further subdivide the at least one slice. By subdividing the slices into angular sectors, a local modification of the 3D socket/stump model is possible which can be advantageously adapted individually to the anatomical conditions of a stump by determining the size of an angular sector.

According to a further embodiment of the invention the at least one slice is subdivided into angular sectors based on the selection of at least one angular sector subdivision—a so-called template—previously specified by the user. Templates, in any quantity, can be predefined manually by a user or automatically created and stored. The creation of the templates takes into account the distribution of the different tissue types in different areas of the 3D socket/stump model. Furthermore, every template is preferably based on at least one anatomical constitution of the 3D socket/stump model, for instance: obese or muscular patient/stump, male or female patient, left leg or right leg, long stump or short stump, or the position of the slice in the stump, for example a distal or proximal stump section. An angular sector subdivision can also be specified or varied individually by the user in order to achieve the best possible adaptation to the anatomical conditions of the stump. Preferably the user selects an angular sector subdivision from a predetermined library of templates. Additionally the method according to the invention can preselect at least one angular sector subdivision for the user based on at least one anatomical constitution and/or the tissue distribution of the 3D socket/stump model. The anatomical constitution can comprise at least the following criteria which can be considered in the preselection: obese—muscular, male—female, left leg—right leg, distal—proximal, long stump—short stump. Furthermore, the preselection can be based on prior user entries or an evaluation of how often which angular sector subdivision was used for a modification in a specific section of a 3D socket/stump model. The preselection can also be made as a result of an evaluation of longitudinal studies with respect to the volume changes in different patient stumps.

According to a further embodiment of the invention, the position of the angular sectors of the at least one slice is adapted to the distribution of one tissue type of the 3D sockets/stump model by rotating the angular sectors about its apex. This is performed by the user. Furthermore, it can be advantageous to apply the rotation of the angular sectors about the stump axis to the 3D socket/stump model after using the knowledge-based rule sets and the volume compression factors. The changed sequence of steps can represent an additional control step for the user in that the executed volume compression or modification of an area of the 3D socket/stump model can be displayed by means of a parameter line in comparison to the unmodified 3D socket/stump model. The orthopedic technician or physician can, depending on the executed compression, achieve improvement of the modification by again rotating the angular sectors and reapplying the knowledge-based rule sets or volume compression factors. Preferably, the rotation of the angular sectors can be completely automatic.

According to a further embodiment of the invention, the modification of the 3D socket/stump model based on knowledge-based rule sets comprises an adaptation on the basis of the outer shape, particularly the curves, of the 3D socket/stump model. The modification preferably further comprises an adaptation to essential bone structures, preferably the ramus ossis ischii and the tuber ischiadieum, because this area can otherwise in the case of incorrect adaptation of the prosthesis sockets lead to pain at the hip for an above-knee amputee (transfemoral amputee) wearing the socket. Preferably, the adaptation to the bone structures occurs based on volume compression values specified as absolute values. For this purpose, the 3D socket/stump model advantageously provides information about the distribution, position and properties of these bones, and the tissue lying around them which simplifies the adaptation. Preferably the 3D socket/stump model is adapted to essential bone structures completely automatically or through user interaction.

According to a further embodiment, during modification of the 3-D socket/stump model a volume change of the socket/stump model essentially parallel to the stump axis—a longitudinal compression—is considered based on the knowledge-based rule sets. In considering the longitudinal compression, the bodyweight of the patient is advantageously included in order to avoid an increase of a point or region of pressure on the stump, particularly at the distal area of the stump, while in contact with the socket to be created.

According to a further advantageous embodiment of the method according to the invention, a surface smoothing of the modified 3D socket/stump model is performed while modifying the 3D socket/stump model, wherein the surface smoothing occurs between two adjacent slices. Whereas in the prior art, manual prosthesis socket production method, a smooth continuous socket surface is the goal which corresponds to a global smoothing of the socket surface, it can advantageously affect the wearing properties of the socket to be created to alternately subject the modified 3D socket/stump model to local, i.e., regionally limited surface smoothing. Preferably the outer surfaces of adjacent, modified areas of the 3D socket/stump model, for example two adjacent slices subdivided into angular sectors, are thereby adapted to each other in the transitional region, after at least one angular sector of at least one of the two slices has been modified according to knowledge-based rule sets in the form of volume compression factors. For this purpose, e.g. a spatial interpolation method or similar can be used. This results in local unevenness in the surface of the 3D socket/stump model. These can advantageously affect the wearing comfort, the hydrostatic attachment and consequently the adhesion properties of the socket to be created. It can also be advantageous to perform local as well as global surface smoothing in different areas of the 3D socket/stump model. The surface smoothing is preferably completely automatic.

The modification preferably causes the stump to have a volume that, when wearing a socket produced according to the 3D socket/stump model and moving the stump under different conditions, differs from the stump volume in a relaxed state without wearing a socket.

Once the modification of the 3D stump model is concluded, production follows, in particular by milling, so that the 3D socket/stump model can be quickly and cost-effectively used as a socket.

According to a further embodiment of the invention, the 3D socket/stump model is produced by milling and/or grinding and/or turning and/or laser cutting and/or deep drawing. Advantageously, the processing method that is suitable for the socket material used in each case, and that is fastest, or a combination of known suitable processing methods is selected.

According to a further embodiment of the invention, an anatomical error in the 3D socket/stump model can be corrected using at least one predetermined 3D pattern. 3D patterns are predefined virtual model sockets or models of partial sockets which take into account specific information inherent in a stump anatomy. Such 3D patterns can advantageously be determined using sample sockets with test patients and then automatically correct anatomical errors in the 3D socket/stump models. The patterns are preferably stored in a database and are selected according to the anatomical conditions of the patient, and are used in the context of modifying the 3D socket/stump model.

According to a further embodiment of the invention, a knee/calf fitted part, located between a prosthesis foot and the socket, can be dimensioned based on 3D image data determined from the unharmed second leg. A CT image as comparison information, for example mirrored symmetry information from the unharmed second leg, can advantageously be used for the construction and the adaptation of the prosthesis and/or the prosthesis socket.

A further aspect of the invention relates to a system for creating a 3D socket/stump model for producing a prosthesis socket for connecting a body part forming a stump to a prosthesis: an acquisition unit for acquiring three-dimensional image data of a body part, comprising multiple tissue types, forming the stump; a segmentation unit for segmenting the 3D image data from the acquisition unit for determining the distribution of at least one tissue type of the stump; a reconstruction unit for reconstructing a 3D socket/stump model based on the segmented 3D image data from the segmentation unit that describes the geometry of the stump and distribution of the at least one segmented tissue type of the stump; a determination unit for determining at least one stump axis based on the 3D socket/stump model; a subdivision unit for subdividing at least one area of the 3D socket/stump model into at least one slice of defined thickness perpendicular to the stump axis, and for subdividing the at least one slice into angular sectors; and a modification unit for modifying the 3D socket/stump model from the reconstruction unit based on knowledge-based rule sets for optimal adaptation of the 3D socket/stump model to the stump, wherein the knowledge-based rule sets consider the information contained in the 3D socket/stump model about the geometry of the stump and/or distribution of the at least one segmented tissue type, and comprise one or more rules that use one or more properties of the at least one segmented tissue type.

A further aspect of the invention relates to an apparatus for user interaction with a 3D socket/stump computer model for modifying the 3D socket/stump computer model which describes the surface shape and spatial tissue distribution of a stump. The apparatus is designed to subdivide the 3D socket/stump computer model into sections, and comprises the following elements: a display that is designed to display the surface shape and tissue distribution in a section of the 3D socket/stump computer model, a first selection module which allows the user to select a section of the 3D socket/stump computer model for display on the display, and a second selection module which allows the user to select at least one predetermined spatial distribution of a modification of the surface shape in the section. The apparatus is designed to modify the surface shape in the section according to the selected spatial distribution. The interaction of a user with a 3D socket/stump computer model preferably comprises every interaction or input of the user using one of the selection modules on which the modification of the 3D socket/stump computer model is based, such as the user viewing the 3D socket/stump computer model or specific sections on a display, selecting specific model sections for display on the display, marking anatomical points in a section, selecting a pre-determined distribution of a modification of the surface shape, etc.

The display can advantageously be a computer monitor which is suited to represent the three dimensional information about the spatial distribution of the tissue types and the surface shape of the imaged stump.

The first selection module preferably comprises an interaction module such as a computer mouse, a keyboard or a touch screen, by means of which the user can select sections of the 3D socket/stump computer model shown on the display, and display them individually and enlarged. The selected section is represented by displaying to the user the surface shape and the spatial distribution of the tissue types contained in the section. Advantageously this representation is a top view of the section, but perspective views are also possible. Additionally, the position of the selected section within the 3D socket/stump model can also be displayed to the user so that he can consider the position while selecting a spatial distribution of a modification.

The second selection module also comprises an input apparatus allowing the user to select a predefined spatial distribution of a modification of the surface shape for the selected section. For this purpose, the user preferably selects from a series of spatial distributions shown on the display. The spatial distributions of the modifications are designed so that they take into account the spatial tissue distribution of a section. A set of predetermined spatial distributions can be stored, for example in a database in a data base module which the second selection module can access. The entries of the database are preferably manually generated, maintained and changed by the user. The apparatus can advantageously also automatically adapt the set of spatial distributions of the modification.

The apparatus modifies the surface shape of the selected section according to the selected spatial distribution of the modification. Preferably, the modification is a volume change in the section. The modification can also be purely a change of shape, or a distortion or skewing of the section. The modification of the 3D socket/stump model advantageously attains an ideal fit of the socket to be created to the present stump.

The embodiment provides the user with a simplified processing flow when modifying a 3D socket/stump computer model because the user is able to individually display sections of the 3D socket/stump model and can modify them according to the tissue distribution by selecting a modification distribution. Predetermined spatial distributions for the modification of each section are advantageously provided to the user from which he can make a suitable selection. This reduces the effort and the required user input when modifying a 3D socket/stump model, and also reduces costs and the duration of the adaptation processes. In addition, the quality of the socket created in this manner is increased.

According to a further embodiment of the invention, the apparatus is designed to allow the user to specify a stump axis using the 3D socket/stump computer model, and to subdivide the 3D socket/stump computer model into sections which are aligned with the stump axis.

To specify a stump axis in a 3D socket/stump model, the user selects two sections, for example sectional images of the stump which were captured by means of a medical imaging method such as CT or MRT, and uses one of the selection modules to select a specific anatomical point in the sections. The user thereby determines two points through which the stump axis runs. Due to the user interaction while specifying the stump axis, the device can individually take into account particular conditions of the stump. While taking into account the position of the stump axis, the device automatically calculates sectional images which run essentially perpendicular to the stump axis. The 3D socket/stump model is modified based on these sections.

According to a further embodiment of the invention, the sections on which the modification is based are slices lying essentially perpendicular to the stump axis. The slices can have any desired thickness. All slices can have the same thickness, for example. Preferably the slices have different thicknesses, for example a greater thickness in the proximal area than in the distal area of the 3D socket/stump computer model because a modification occurs in the proximal area on the basis of the bone structure there, which permits a less refined division. The apparatus is advantageously designed so that the user can determine the thickness of a slice individually. If a 3D socket/stump model shows special characteristics in the tissue structure, these can be taken into account individually when dividing up the 3D socket/stump computer model. The thickness of a slice can be determined, for example by user input of a value via the keyboard, or by selecting the value from a series of values presented for selection.

According to a further embodiment of the invention, the predetermined spatial distribution comprises a subdivision of the section into at least one subsection, wherein each subsection is assigned at least one value on which the extent of the modification of the surface shape is based. The subsections are preferably shaped so that they take into account the geometry of the 3D socket/stump computer model. Preferably, at least one fixed value is specified for each of the subsections based on which the extent of the modification in this subsection can be specified. The division of a section into subsections during the modification of the 3D socket/stump computer model attains a reduced computational effort because there are only a fixed number of values for each subsection which characterize the modification in this subsection. By finely subdividing the section into many small subsections with corresponding values, the accuracy of the modification can, however, be increased, for example when so required by the anatomical conditions of the 3D socket/stump computer model.

According to a further embodiment of the invention, the apparatus is designed to derive a change in volume of one of the tissue types in the subsection based on the value and the tissue distribution in the subsection, and to determine the extent of the modification of the surface shape based on the volume change.

According to a further embodiment of the invention, the tissue types in the 3D socket/stump computer model comprise fat, muscle, skin and/or bones. The value of the volume change of at least one of the contained tissue types can indicate the percent volume change of the respective tissue type, or an absolute volume change. The value of the volume change of at least one of the contained tissue types can preferably be based on the compressibility of the respective tissue type.

According to a further embodiment of the invention, the second selection module allows the user to manually change the value for the modification in at least one subsection. Preferably this can occur through a query from the device or through an entry of a changed value from the user. It is advantageous that the user is not limited to the proposals for the modification presented to him for selection, and that he can perform a local adaptation of the modification proposal for an angular area if so required by the anatomical conditions of the 3D socket/stump computer model. Large parts of a predetermined spatial distribution of the modification can be retained in this manner. Thus, the user can preferably perform a further control step.

According to a further embodiment of the invention, the spatial distribution of the modification comprises subsections which form angular sectors, which are disposed radially outwards from the stump axis. This corresponds to an optimal consideration of the approximated cylindrical symmetry of a stump with the modification of the 3D socket/stump computer model. In the case of particularly short stumps it can be advantageous to deviate to a different subdivision, or completely to a different form of sections, which for example are taken from a spherical symmetry.

According to a further embodiment of the invention, the apparatus allows the user to manually change the spatial alignment of the angular sector by rotation about the stump axis using the second selection module. For this purpose, the selected spatial distribution is preferably overlaid with the selected section, and the overlay is displayed to the user. The user can now rotate the distribution over the section until the different tissue types are optimally assigned to the angular sectors. Preferably the user can further rotate the distribution over the section after having modified the surface shape of the section if he is not completely satisfied with the results of the modification.

According to a further embodiment of the invention, the surface shape modification is designed to substantially retain the shape of the surface of the subsection forming the outer surface of the 3D socket/stump computer model For this purpose, a subsection is preferably modified so that the side of an angular sector forming the outer surface of the 3D socket/stump computer model is radially displaced according to the extent of the volume change, and the transition areas between the sides of the two adjacent angular sectors forming the outer surfaces undergo smoothing. The extent of the volume change of the angular sector results from the volume change factor for at least one tissue type contained in the angular sector.

According to a further embodiment of the invention, the second selection module is designed so that the predetermined spatial distributions from which the user can select for the respective section depend on the position of the section within the stump, the tissue distribution of the section and/or physiological or anatomical properties of the stump or of the patient. This preferably comprises a division of the different spatial distributions of the modification into the following categories: distal or proximal, long stump or short stump, left leg or right leg, muscular or obese stump, male or female, etc. The spatial distributions are preferably stored in the named categories in the database. By evaluating the selection of a section by the user and/or the tissue distribution contained therein, or other characteristic values of the 3D socket/stump computer model such as the length of the stump, the apparatus can preselect the spatial distributions for the user and present just them, from which the user then chooses. The intelligent preselection and/or filtering of the spatial distributions by the apparatus can further accelerate the adaptation process.

According to a further embodiment of the invention, the apparatus also comprises a database module in which the predetermined spatial distributions are stored, and the apparatus is designed to adapt the set of the spatial distributions in the database based on an analysis of previous modifications of the 3D socket/stump computer model of other and/or the same patients. The analysis preferably comprises how often a user selected a spatial distribution for a section. The apparatus thereby creates lists of spatial distributions which indicate the importance of a spatial distribution. Unimportant spatial distributions, that is, spatial distributions that are rarely used or not used at all, are deleted from the database after expiration of a fixed period, whereas important, i.e., frequently used spatial distributions are preferably presented to the user for selection. The modification of a 3D socket/stump computer model can be continuously optimized by this self-learning process. Further, the analysis can comprise how frequently and to what extend the user changed a spatial distribution after the selection for a section. The change of the compression values, for example, can be recorded and evaluated. Corresponding to this adaptation by the user, already existing spatial distributions can either be modified, or new spatial distributions can be created in the database.

According to a further embodiment of the invention, the second selection module is designed so that the predetermined spatial distributions from which the user can select for the respective section, take into account an expected physiological change of the stump. The expected physiological changes of the stump comprise the reduction of muscle tissue, which after an amputation is subject to atrophy due to inactivity, an increase of the fat portion in the stump, etc. These changes can typically occur frequently with amputees. Significant average stump changes can be determined by measuring many patients' stumps in the scope of longitudinal studies. The longitudinal studies can measure a patient stump, for example, immediately after the amputation, and then at a specific temporal interval. The information thus acquired about the average change to be expected in the stump is transmitted to the apparatus using feedback and is evaluated by the apparatus. After the user selects a spatial distribution for a section, for example, a query can follow of whether the change to be expected for this section should be considered. If the user confirms this, the compression values in the angular sectors are modified. Alternatively, spatial distributions that already take into account the Information about expected changes, for example by automatically increasing the compression values in the individual angular sectors, can be stored in the database so that a query becomes superfluous. Furthermore, alter a section by section modification, the 3D socket/stump computer model can be modified globally considering the information about expected changes. Advantages of considering the expected changes of the stump can be extended wearing time of the socket produced in this manner, because the expected shape of the stump is used for producing the socket instead of the actual shape of the stump. Through slight deviations from the current optimal fit towards a future optimal fit, the wearing time of a socket can be significantly increased along with the degree of activity and as well as the quality of life of a patient.

A further aspect of the invention relates to a method for user interaction with a 3D socket/stump computer model for modifying the 3D socket/stump computer model which describes the surface shape and spatial tissue distribution of a stump. The method comprises the following steps: subdivision of the 3D socket/stump computer i model into sections, selection by the user of a section of the 3D socket/stump computer model for displaying on a display, displaying the surface shape and tissue distribution of the selected section on a display, selection by the user of at least one predetermined spatial distribution of a modification of the surface shape in the section, and modification of the surface shape in the section corresponding to the selected spatial distribution.

According to a further embodiment of the method according to the invention, a stump axis is specified based on the 3D socket/stump computer model, and the 3D socket/stump computer model is subdivided into sections which are aligned with the stump axis.

According to a further embodiment of the method according to the invention, the predetermined spatial distribution comprises a subdivision of the section into at least one subsection, which is disposed radially outward from the stump axis, wherein each angular sector is assigned at least one value on which the extent of the modification is based.

According to a further embodiment of the invention, the spatial alignment of the angular sectors is manually changed by the user by being rotated about the stump axis.

According to a further embodiment of the invention, the value can be changed manually by the user.

According to a further embodiment of the invention, the shape of the surface of the subsection forming the outer surface of the 3D socket/stump computer model is essentially retained during modification.

A further aspect of the invention relates to a computer program that is suited to perform the method according to the invention. The computer program is particularly suited for executing a method for the user to interact with a 3D socket/stump computer model to modify the 3D socket/stump computer model. The computer program is preferably stored on computer readable media. The computer program can be present as a computer program product in the form of a CD, DVD, or any other transportable data storage, for instance a USB stick. The computer program can alternatively be stored as a computer program product on the hard disk a computer. Alternatively, the computer program can be stored centrally on a server and can be called and/or executed by a user via the Internet and/or a local network. The computer program product is advantageously suited to execute the method according to the invention when the computer program runs on a computer. The program code preferably comprises executable code and/or source code of the computer program according to the invention.

A further aspect of the invention relates to a system for the user to interact with the 3D socket/stump computer model to modify the 3D socket/stump computer model. The system comprises: a reading unit for reading in 3D image data of the stump, a segmentation unit for segmenting the 3D image data for determining the spatial tissue distribution of the stump, a reconstruction unit for reconstructing a 3D socket/stump computer model based on the segmented 3D image data which describes the surface shape and spatial tissue distribution of the stump, an apparatus for user interaction which modifies the 3D socket/stump computer model considering user input, and an output unit which outputs the modified 3D socket/stump computer model for further use for producing a prosthesis socket.

### BRIEF DESCRIPTION OF THE DRAWINGS

Further preferred example embodiments of the invention are described below in more detail based on schematic drawings. They show:

FIG. 1 a flow chart according to one example embodiment of the invention;

FIG. 2 tomography in frontal planes according to one example embodiment of the invention;

FIG. 3a a slice of segmented tissue types according to one example

embodiment of the invention;

FIG. 3b a slice of segmented tissue types according to one example embodiment of the invention;

FIG. 4 a creation of a socket according to one example embodiment of the invention;

FIG. 5 positions of axes according to an embodiment of the invention;

FIG. 6 several slices according to an embodiment of the invention;

FIG. 7 a slice with angular sectors according to an embodiment of the invention;

FIG. 8a a flow chart according to an embodiment of the invention;

FIG. 8b a flow chart according to one example embodiment of the invention;

FIG. 8c a flow chart according to one example embodiment of the invention;

FIG. 9 a representation of a surface smoothing of the compressed 3D socket/stump model according to one example embodiment of the invention;

FIG. 10 a schematic force distribution on the stump while in contact with the socket to be created according to one example embodiment of the invention;

FIG. 11 an interaction diagram of a user with a 3D socket/stump computer model according to one example embodiment of the invention;

FIG. 12 an interaction diagram of a user with a 3D socket/stump computer model according to one example embodiment of the invention;

FIG. 13 a schematic representation of a database with templates according to one example embodiment of the invention.

### DESCRIPTION OF PREFERRED EMBODIMENTS

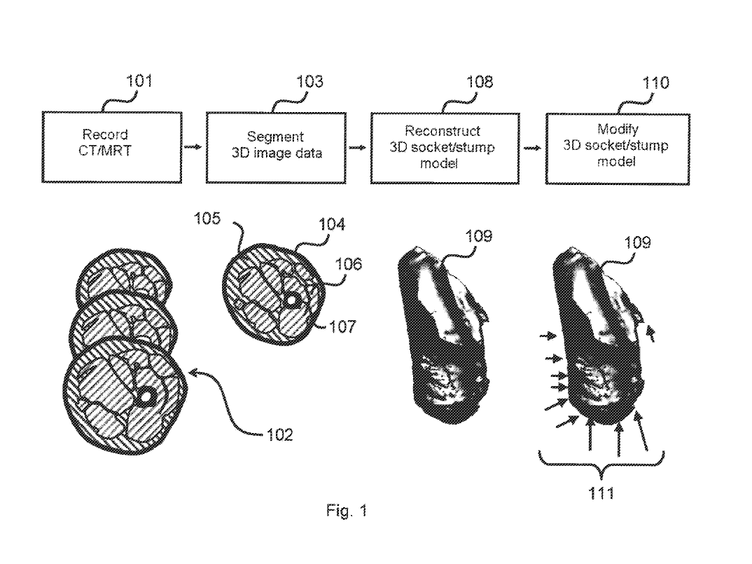

FIG. 1 shows a flow chart according to one example embodiment of the invention that comprises the following steps (in this sequence): step 101 (acquisition unit) CT and/or MRT layer captures tomographies 102 for acquiring 3D image data of the stump which results in a cloud of density points; step 103 (segmentation unit) segmenting of 3D image data for determining a distribution of tissue types of the stump comprising the skin 104, fat 105, muscles 106, and bones 107; step 108 (reconstruction unit) reconstructing a 3D socket/stump model 109 based on segmented 3D image data, and step 110 (modification unit) modifying the 3D socket/stump model based on the compressibility of the segmented tissue types 105 to 107. The arrows 111 symbolize manual or automatic modifications, distortions and/or skewings of the 3D socket/stump model, wherein the length of the arrows qualitatively represents the degree of modification.

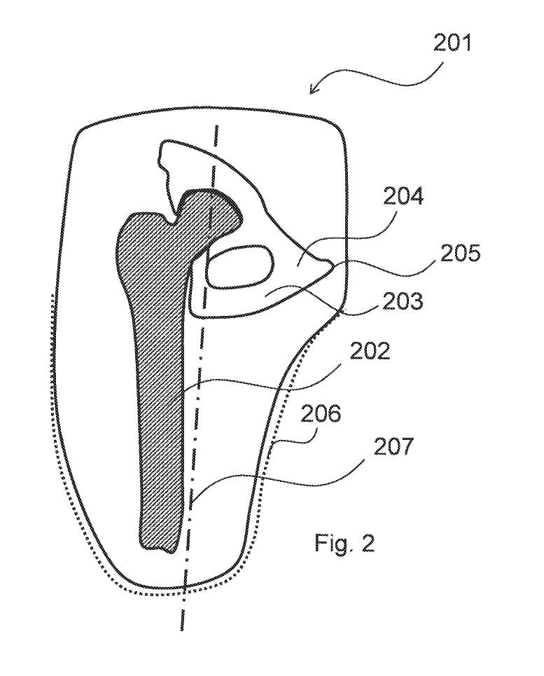

FIG. 2 shows a tomography 201 of a stump recorded in a frontal plane. The femur (thigh bone) 202, the os coxae (hip bone) with the os ischii (ischium) 204 and specifically the ramus ossis ischii (branch of the ischial bone) 203 can be seen in the tomography 201. The 3D socket/stump model to be modified in step 110 (see FIG. 1) is to be adapted in particular so that a socket worn on the stump exerts a firm pressure on the ramus ossis ischii 203 and/or tuber ischiadicum 205 to achieve the goal of the prosthesis being easily checkable and controllable, and to prevent, excessive pressure from being exerted on the tissue surrounding the bone structures so as not to disrupt the blood flow in the stump while wearing the socket.

FIG. 2 further shows a liner 206 which can be pulled over the stump in the manner of a stocking. The liner 206, composed of silicone or other suitable materials, produces a density threshold value in the CT image so that surrounding unnecessary structures, e.g., the CT table, other (unharmed) leg, genitals, etc. can be easily distinguished from the stump tissue. The liner 206 also provides a slight initial compression which counteracts potential lateral shaping of the stump when the patient lies on the CT table.

A stump axis 207, defined in FIG. 2, passes through a point of the articulatio coxae (hip joint) and for example through to a point of the imaginary articulatio genus (knee joint) or another point relating to the motor function of the stump.

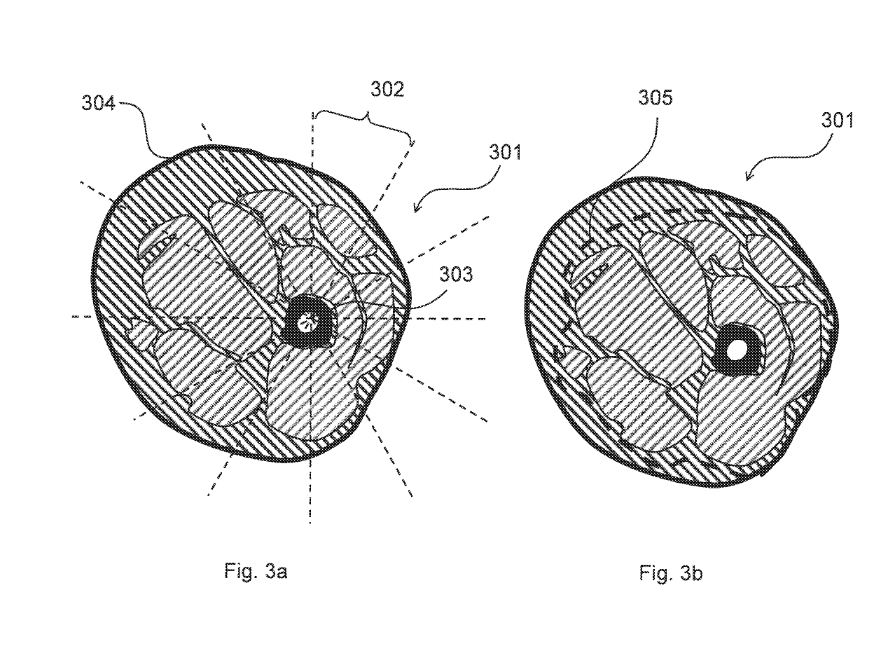

FIG. 3a shows an approximately 1 cm thick slice 301 of segmented tissue areas from a 3D socket/stump model. The slice 301 is subdivided into twelve equal angular sectors 302 which extend radially starting from the center of the femur 303 to the surface 304 of the stump. In the angular segments 302, a quotient composed, for example, of the partial volumes of fat and musculature at that site, together with a compression value specified for each tissue type, forms an initial basis for individually modifying the tissue areas in the angular sectors 302 in the 3D socket/stump model. In addition, empirical values from series of measurements of test subject sockets can be included as a further dimensioning factor for the modification. Alternatively, only the compression number of the fatty tissue can be included during modification. In that case, other tissue types are not considered during modification.

The modification of the 3D socket/stump model can be subdivided particularly in an adaptation of a distal and a proximal stump part. For this purpose, a reference plane and a zero plane are preferably defined, wherein the reference plane intersects the distal part of the tuber ischiadicum.

The adaptation of a distal stump part starts approximately 5 cm below the tuber ischiadicum 205, where the zero plane can be advantageously defined, in 1 cm slices or slices of different thicknesses as described above. This corresponds, above all, to a hydrostatic attachment of the distal portion of the socket. The adaptation of the distal portion of the stump preferably ends in the layer which comprises the distal end point of the femur 303.

The proximal stump part is adapted using knowledge-based rules which are oriented to the bony structure of the femur 303, the os coxae and important hip muscles. According to the knowledge-based rules, first there is a virtual rectangular exposure of the tendon of the adductor longus, a frontal, planar support of the musculus rector femoris, a complete cut-out of the gluteus maximus, and a pretensioning of the adductor magnus. A subsequent encompassing of the tuber ischiadicum 205 is followed by a medial encompassing of the ramus, and planar encompassing of the trochanter with planar placement of the greater trochanter.

FIG. 3b shows a result of an individual modification of the tissue types in the angular sectors 302 of the 3D socket/stump model slice 301. For FIG. 3b, smaller angular sectors 302 were selected, e.g. with a central angle or vertical angle ranging from approximately 5 to 20°. The new contour 305 corresponds to an optimal adaptation of the 3D socket/stump model to the stump by reducing the face side of the angular sectors 302 using knowledge-based rules.

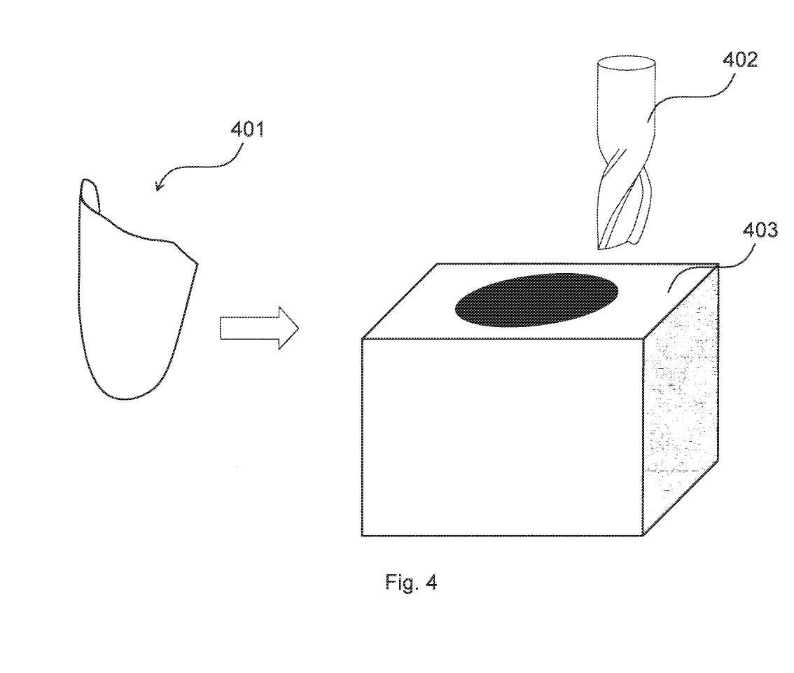

FIG. 4 shows a 3D socket/stump model 401 generated according to step 110 (see FIG. 1). The 3D socket/stump model 401 is converted in an intermediate step into CAD data for a conventional control of a milling machine. A milling tool 402 then mills the socket or a socket positive from a solid material 403.

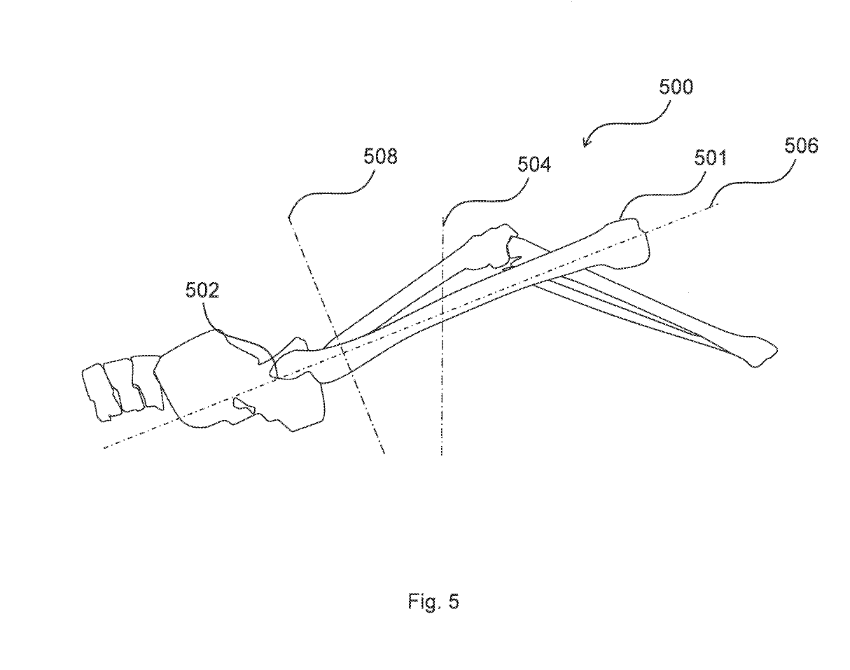

FIG. 5 shows positions of axes in a 3D socket/stump model 500. A stump-forming body part having a femur 501 lies in FIG. 5 in an upwardly angled position, i.e. the femur 501 is bent, at a point in time at which 3D images of it were acquired. A CT produces structurally-related sectional images that are aligned parallel to the axis 504 and that do not optimally take into account the symmetry of the stump. During the reconstruction of the 3D socket/stump model, e.g. step 108, an upper stump axis point is advantageously defined at the fossa acetabuli 502. The fossa acetabuli 502 lies at the center of the articulatio coxae (hip joint) so that the upper stump axis point is disposed in its center of movement, corresponding to the motor function. A lower stump axis point preferably lies at the geometric center of the distal end of the body part forming the stump. The upper and lower stump axis points define a stump axis 506 which is independent of the recording modality used. The 3D socket/stump model 500 can be subdivided into slices or areas perpendicular to the stump axis 506 and parallel to axis 508. The stump axis 506 runs, for example, in the main direction of forces acting on the body part forming the stump.

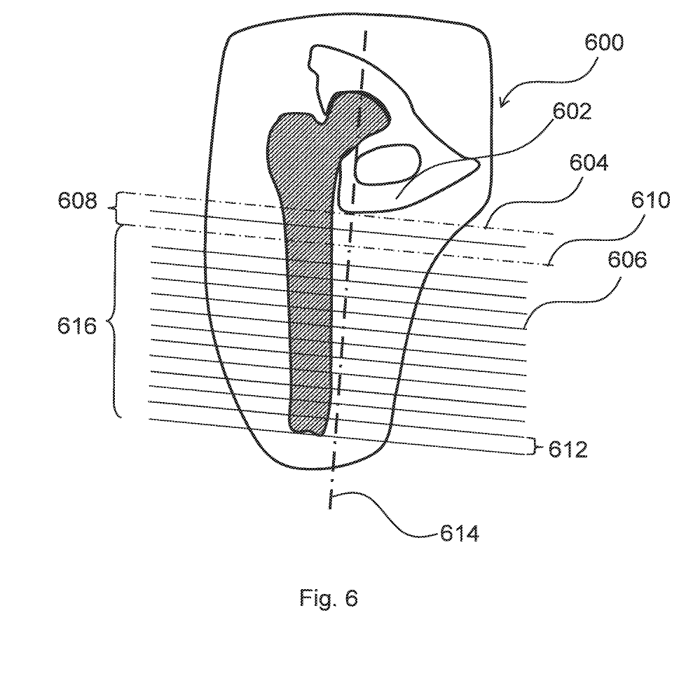

FIG. 6 shows a 3D socket/stump model 600 and multiple slices or cuts 604, 606, 610 therein which are disposed substantially perpendicular to a stump axis 614, and which subdivide the 3D socket/stump model 600. The slice 604 corresponds at its upper side to the distal end of the tuber 602 of the reference plane 604, and forms a reference plane for determining further slices or planes 604, 610, 606, The plane 610 is offset at a predetermined distance 608 from the reference plane 604, e.g., 5 cm. This is the zero plane 610 which separates the distal 616 and the proximal 608 stump. Any number of further distal slices 606 are adjacent thereto. The slices can have any desired thickness 616. It can be advantageous for the thickness 612 of the slices 606 to increase toward the distal end of the 3D socket/stump model 600. The thickness of the slices 606, 608 can be inverse to the complexity of the tissue areas and/or anatomy and/or the distribution of tissue types contained in the slices 606, 608. A more exact adaptation of the 3D socket/stump model 600 to the stump near the tuber 602 can be made possible by a smaller thickness 612 of the slices 604. Alternatively, when adapting in the proximal area 608, a larger slice thickness 608 can be advantageous if the 3D socket/stump model is to be adapted to essential bone structures by means of volume compression factors specified as an absolute value.

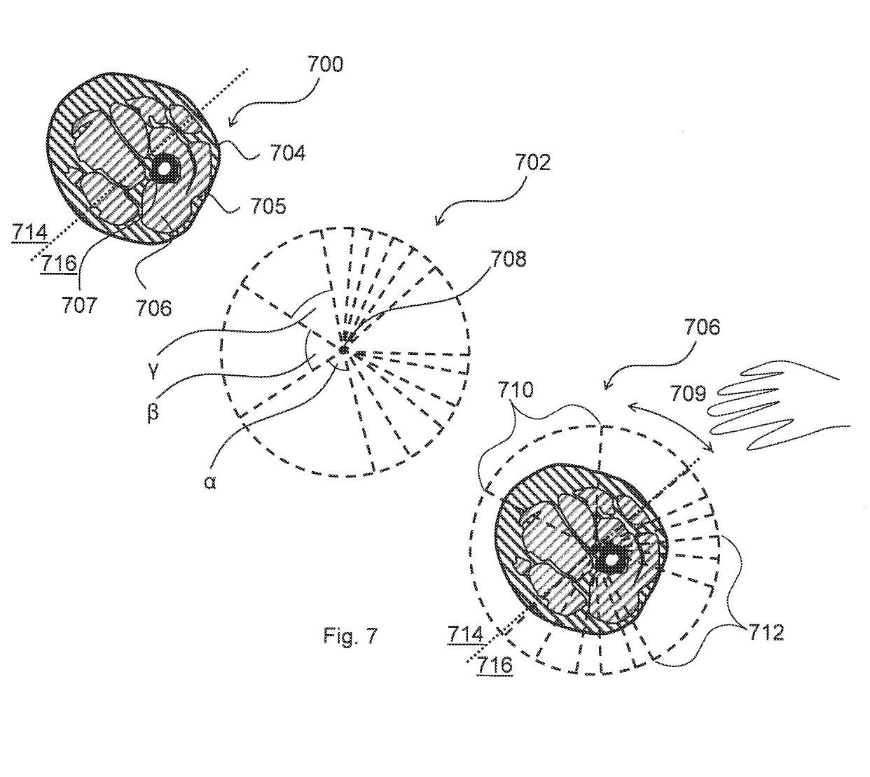

FIG. 7 shows a slice 700 with angular sectors 702. Because different slices 700, depending on their position in the 3D socket/stump model 600, can have different distributions of the tissue types, e.g. skin 704, fat 705, muscle 706 and bone 707, the slice 700 is subdivided into a specific number of angular sectors 702. The angular sectors 702 can have, as shown in FIG. 7, different angular portions or central angles α, β, γ. The central angles α, β, γare preferably smaller medially 716 than laterally 714. This is particularly expedient if, for example, adaptations are to be made to essential bone structures in the proximal area of the stump. Thus, the medial angular sectors 712 all contain a part of the femur bone 707 which cannot be compressed. In order to enable an exact adaptation in this case, the selected angular sectors 712 are small. In contrast to this, the angular sectors in the lateral area 710 have large portions of fat. The center point 706 of the angular sectors 702 is brought into correspondence with the stump axis, e.g., 207, 506, 614. An optimal overlay of the tissue distributions in the 3D socket/stump model with the angular sectors 702 in each slice 700, 301, 606, 608 can be attained by means of rotation 709, for example by the user, of the angular sectors 702 about the stump axis.

For example, the sectors 710 of the slice 700 would permit greater compression because they contain more compressible tissue types, such as muscles 706 and fat 705, than the sectors 712, The sectors 712 contain little compressible fat 705 and a section of the non-compressible femur 707.

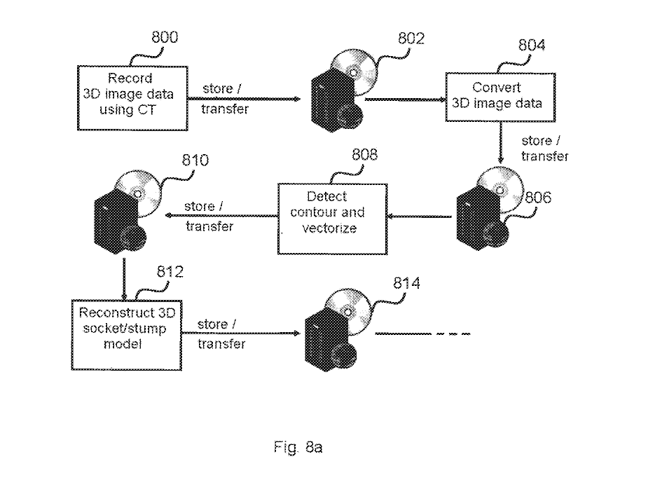

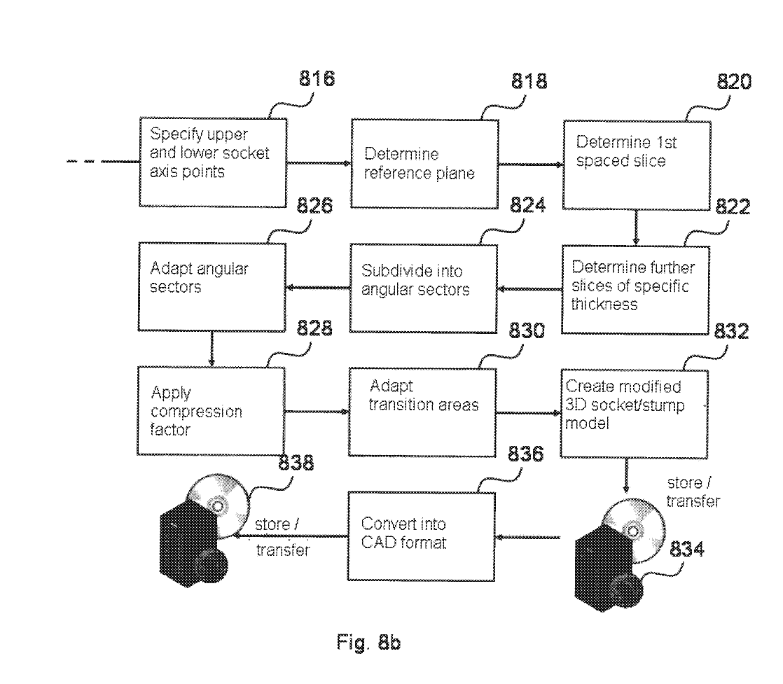

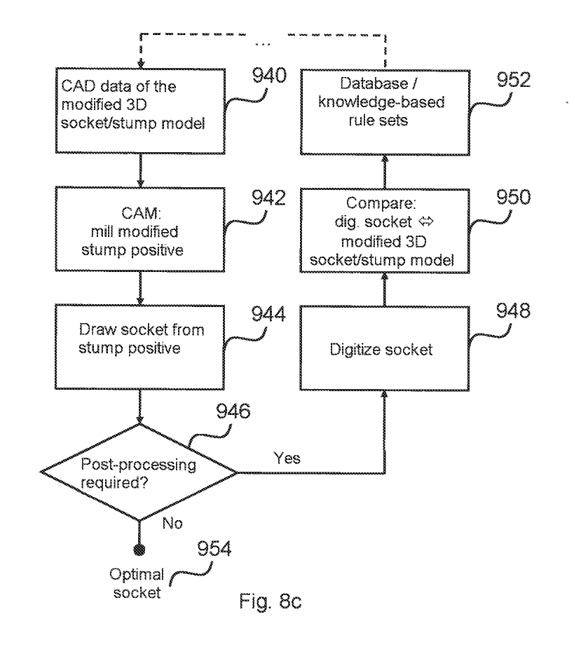

FIG. 8a and 8b show a flow chart for creating a 3D socket/stump model. First, in step 800, 3D image data is captured by means of CT and then, in a storage step 802, is transferred to a server and/or stored there or stored on a storage medium so that it can be transported. In the following step 804, the 3D image data from step 800 are converted into a different storage format; this is followed by a further storage step 806. A step 808 for contour detection and vectorization of the converted 3D image data creates segmented 3D image data which in turn undergo a storage step 810. In the following step 812, a 3D socket/stump model is reconstructed from the segmented 3D image data and again subjected to a storage step 814. In step 816, an upper and a lower stump axis point are determined which together can define a stump axis. In the following step 818, a reference plane is specified. After that, a zero plane is defined at a predetermined offset from the reference plane. In the following step 822, further slices, e.g., slices 606 are specified which each have a specific thickness e.g., thickness 612. Following that, in step 824, a slice is subdivided into angular sectors, wherein the angular sectors can be adapted in step 826 to the distribution of the tissue types in the respective slice. In step 828, compression factors are applied to the individual angular sectors of the respective slice. Here, the outer surface of an angular sector is preferably retained and merely displaced. The extent to which the outer surface is displaced is determined based on the compression values present in the angular sector. If, for example, there is only a compression value for fat tissue in an angular sector, then the compression of fat tissue is converted into a resulting compression factor for the angular sector which takes into account the different tissue portion in the angular sector. If there are compression values for fat tissue and muscle tissue, for example, then a resulting compression value is determined for the angular sector based on these two compression values and the existing tissue distribution. From this, the distance can be calculated by which the outer surface must be radially displaced. Due to the compression of the slices, step-like transition areas between adjacent slices can occur. In the following step 830, these transition areas are adapted or smoothed. Then in step 832, a modified 3D socket/stump model is created and subjected to a storage step 834. Finally, the 3D socket/stump model is converted into a CAD format in step 836, and then there is a final storage step 838. Thus, a milling machine can use the 3D socket/stump model in CAD format to create a prosthesis socket.

The steps 824 to 830 can be iterated for the number of slices provided in each case. In step 824, a plurality of predefined angular sectors 702 can be used that each have a predefined angular portions α, β, γ which are adapted in step 826 only to the distribution of the tissue types, e.g., by rotating the angular sectors 702. The same applies for the use of compression factors in step 828. These can be changed manually by the user. The adaptation of the transition areas in step 830 can occur with each iteration, or for all transition areas only at the conclusion. Further, steps can be exchanged and combined with other steps, e.g. specification steps. In addition, steps can be omitted, for example, storage steps, transformation or conversion steps.

FIG. 8c shows a further flow chart for revising and/or improving the adaptation of a socket. The steps shown in FIG. 8c directly follow step 838 in FIG. 8c. First, in step 840, the data of the modified 3D socket/stump model converted into a CAD format is transferred to a milling machine which, in step 842, creates a stump positive of the modified 3D socket/stump model 401 based on the CAD data (see FIG. 4). In step 844, a socket can now be produced from the stump positive using various methods and materials. The socket is preferably a carbon socket or a glass fiber socket. The socket shape corresponds to the negative of the stump positive. In a further step 846, a decision can now be made as to whether the created socket requires further processing. This decision can be made after a single fitting of the socket by the patient, or it can be made after the patient has worn the socket for a longer period of time. If the patient does not experience any discomfort while wearing the socket, then further processing is not necessary and the method has generated an optimal socket 854 in a single cycle. If however, further adaptations are necessary after an examination, then in a next step 848 the shape of the generated socket can be digitized. The digitization is preferably realized using optical scanning methods, for example by means of a laser. In a next step 850 using the shape information about the created socket, first a comparison can be made with the desired socket to be created to allow the exclusion of manufacturing errors.

Further, it can be advantageous during the creation of a socket to consider the typical changes of the tissue distribution or tissue volume changes of a socket to be normally expected in the temporal course of wearing a socket. Thus, for example, the muscle tissue degenerates shortly after the amputation. These typical changes can be determined using the measurements of a plurality of patients' stumps. The statistically significant typical tissue changes can be stored in a database, and can be used in the modification of a 3D socket/stump computer model. Based on this additionally considered information, a “target shape” of the socket can be determined. The information stored in a database comprises information about the development of the shape of a stump over time from a plurality of patients. This information can be statistically evaluated to yield a significant, average shape change which can be used for creating a “prognosis socket”. A prognosis socket is advantageous when it. automatically takes into account the expected shape changes of the shaft, allowing the periods after which an adaptation to the shaft is necessary to be extended. The shape information 952 stored in a database for a plurality of patients can be taken into account and evaluated as parameters by the knowledge-based rule set, and can lead to a change of the underlying knowledge-based rules.

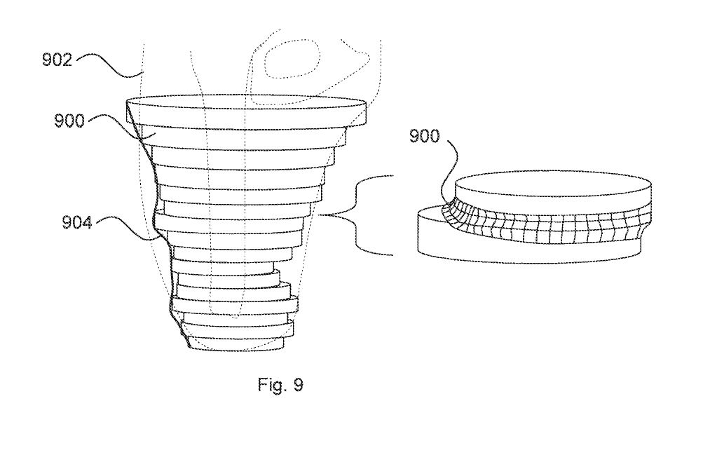

FIG. 9 schematically shows the smoothing process between different compressed areas of the 3D socket/stump model. The compressed, overlying layers 900 form the compressed 3D socket/stump model. The outer surfaces of the individual compressed layers 900 correspond to the contour line 305 in FIG. 3b. For the purposes of illustration, the uncompressed socket shape 902 was overlaid using dotted lines. Local unevennesses which result from the individual compressed layers, are compensated corresponding to a global smoothing represented by the surface contour 904 so that a homogeneous model surface results. Alternatively, local smoothing 906 of the model surface can preferably be performed. The transition areas of adjacent layers 900 are conformed to each other so that overall a rough, non-homogeneous model surface results. This can bring about advantageous wearing properties.

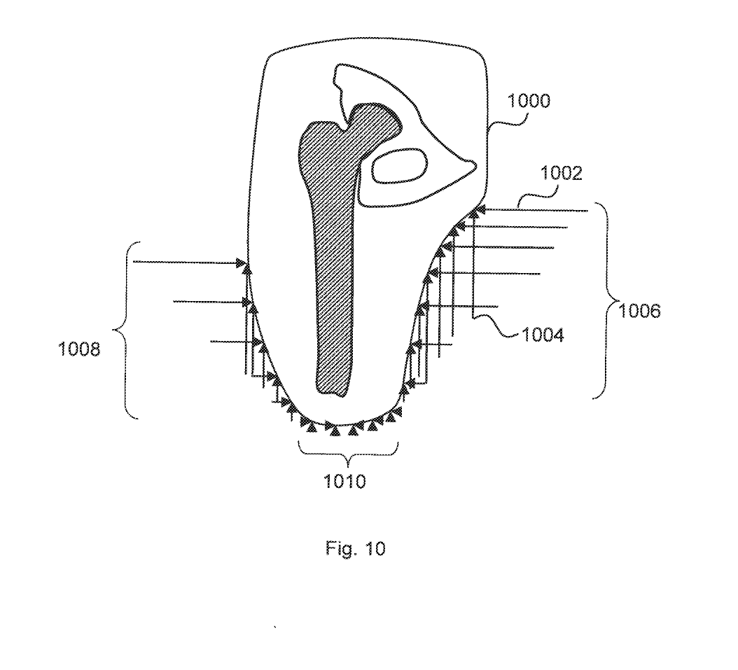

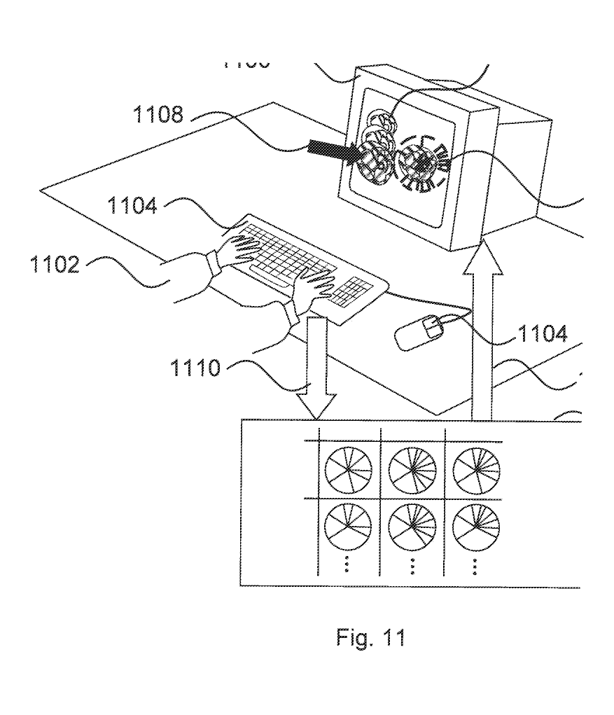

FIG. 10 shows the application of force on the stump, while in contact with the socket to be created, corresponding to the changes or compressions applied to the modified 3D socket/stump model. Here, the arrows 1008 represent a lateral force distribution on the stump, the arrows 1006 represent a medial force distribution on the stump, and the arrows 1010 represent a distal force distribution. Typically, the distal force distribution is equal to, or nearly equal to zero, Further, FIG. 10 distinguishes vertical force components, such as arrow 1004, which act substantially parallel to the stump axis, and horizontal force components, such as arrow 1002, which act substantially perpendicular to the stump axis. The resulting application of force results from the sum of all force components. The application of force decreases globally from proximal to distal corresponding to an optimal pressure distribution and/or force distribution. By taking into account further parameters such as the body weight of the patient, the method according to the invention can determine an optimal longitudinal compression of the 3D socket/stump model.

FIG. 11 shows the user interaction 1102 with a 3D socket/stump computer model using at least one interaction module 1100, 1104, for example, a computer monitor, a mouse or keyboard for displaying information and entering input. In a first step of the interaction 1108, the user using the interaction interface 1104 can select a section 1106 of the 3D socket/stump computer model and display it using the computer monitor. The display is such that the different segmented tissue types in the section are displayed for the user. In a second step of the interaction 1116, the user uses a selection module 1112, for example the computer with templates and/or spatial distributions stored in a database, to select at least one spatial distribution of a volume change for the displayed section. A spatial distribution is, in particular, a subdivision of the section into angular sectors. For this purpose, the user can select a template, e.g., by means of input 1110 via the Interface 1104, from a table of templates (see FIG. 13) which are shown to him via the interaction interface 1100. The input 1110 is processed by the selection module 1112 and converted into an output 1114, which corresponds to a command to overlay the selected template 1116 with the section 1106. The overlay of the template and the section can be displayed to the user. Together with the template, the user also selects compression factors for each subsection of the template. In a further step, the user can change a compression value i of a subsection by subsequent input and improve the adaptation to the tissue distribution in the section. In addition, the user better adapts the subsections of a template to the tissue distribution, e.g., by rotating. With a confirmation by the user, the knowledge-based rule sets are applied to the section so that a volume compression of the section is performed (see FIG. 3). The compressed section can also be displayed to the user so that he has the opportunity to check the resulting compression. If the user is not satisfied with the result, he can perform an optimization step again by again rotating the template, and repeating the compression step with the adapted position of the template relative to the section, and/or again changing again at least one of the volume compression factors in one of the angular sections. If the user accepts the result of the compression, he can then in a further step select a further section of the 3D socket/stump model and modify it as described.

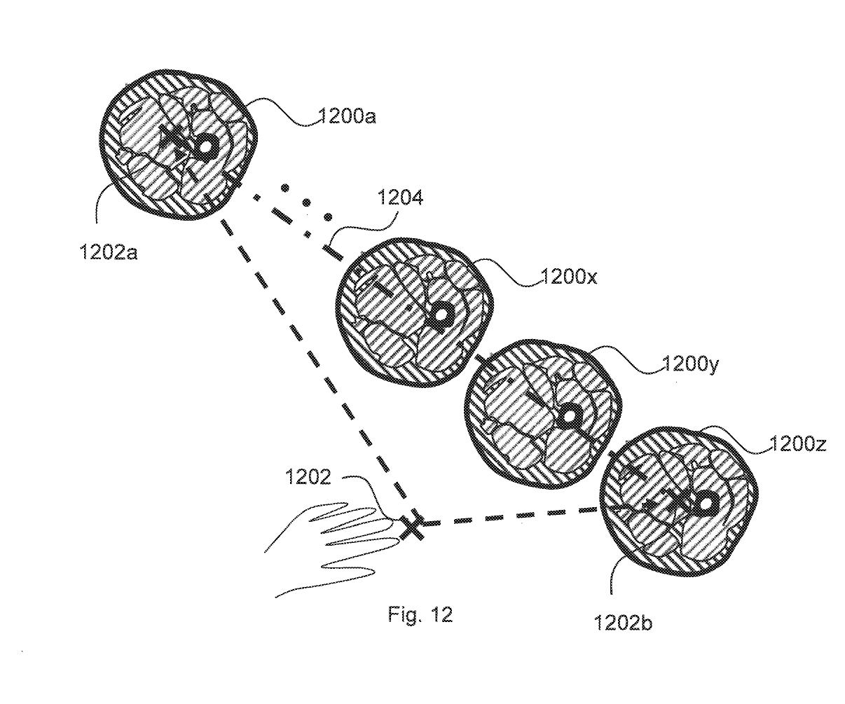

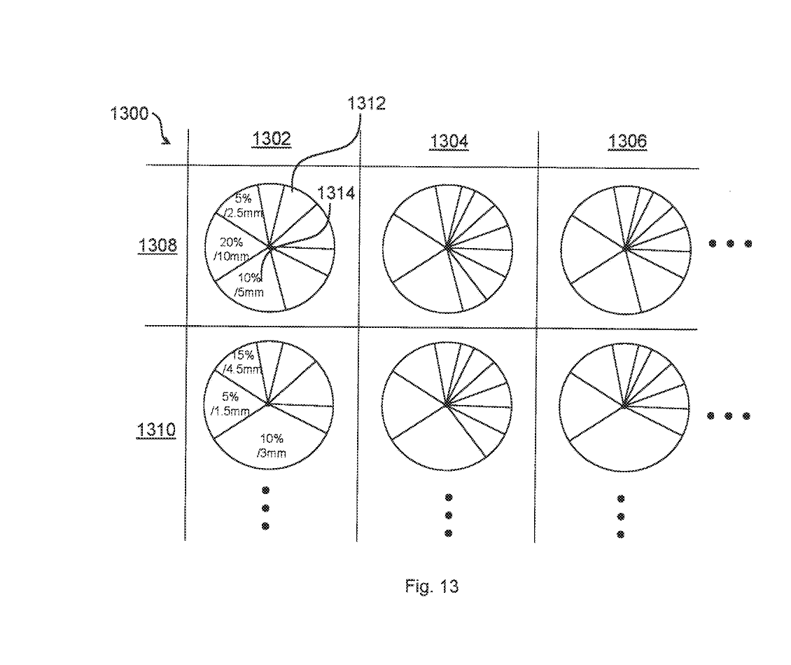

FIG. 12 shows the user interaction (represented by the hand) with a 3D socket/stump computer model for specifying a stump axis in the 3D socket/stump computer model. Here, the user first selects a sectional image 1200x, 1200y or 1200z which was recorded by means of a medical imaging method, e.g., MRT or CT, which represents a section from the distal area of the 3D socket/stump computer model. The user uses this sectional image to determine a distal point 1202b through which the stump axis should pass. The user can further choose to have the selected distal sectional image displayed and, via the interaction interfaces for example, can place a point 1202 that is freely movable on the display of a computer monitor at the desired position in the selected sectional image. The user preferably specifies the point in the geometric center of the sectional image or through the center of the femur. An analogous step sequence is performed when specifying a proximal point 1202a which is located in a proximal section 1200a. Here, the proximal point of the section axis is preferably specified at the bone or cartilage structures of the hip joint. Then, a stump axis is calculated which passes through both specified points. Based on the specified stump axis, the 3D socket/stump computer model can be subdivided into slices of specified thickness which are disposed substantially perpendicular to the stump axis.

FIG. 13 shows an excerpt of a template library 1300. The template library is preferably stored in a database in a database module which the second selection module can access. The template library comprises a plurality of spatial distributions of the modification 1312 for slices in a 3D socket/stump computer model and the compression factors 1314 belonging to it; for example, this can be an angular sector subdivision for a spatial subdivision. Each angular sector is assigned a compression value or a plurality of compression values for different tissue types contained in the subsection. The compression factors 1314 are indicated as a percentage or correspond to an absolute volume change. A compression value can indicate a volume change of 5%, for example. Alternatively, a compression value can also be 5 mm. Then, the side of the angular sector forming the outer surface of the 3D socket/stump computer model is radially displaced by this amount which results in a corresponding volume change. The spatial distributions are assigned to different categories 1302, 1304, 1306, 1308, 1310 in the database 1300, which makes it easier to manage the spatial distributions. The categories are preferably specified based on the position of a selected section within the stump. Thus, spatial distributions are found under the category of proximal 1308 and distal 1310. Further, the categories can take into account the physiological or anatomical conditions of a patient's stump and/or the patient himself and/or the tissue distribution in one section. Thus, the spatial distributions differ, for example, for a male and a female patient, or for a left or right stump. Whether the stump is a long or short stump also comes into consideration when selecting a template. The category 1302 can, for example, comprise spatial distributions for left side long stumps of male patients who have a high overall percentage of muscle, whereas category 1304 contains spatial distributions for short stumps of a female patient with a higher fat content. The list of categories is not final. The creation and/or adaptation of the spatial distributions and/or templates in the database can be performed manually by the user, or occur automatically via a self-learning process with evaluation of, for example prior modifications of a 3D socket/stump computer model. An adaptation of the spatial distributions in the database 1300 can comprise a removal, an addition and/or a change of individual spatial distributions 1312. In the adaptation of individual spatial distributions, the angular sector subdivision can be adapted and/or Its compression values can be changed. Further, the adaptation of the spatial distributions can also comprise the deletion or creation of entire categories of spatial distributions.

1. An apparatus for interaction of a user with a 3D socket/stump computer model to modify the 3D socket/stump computer model that describes a surface shape and spatial tissue distribution of a stump, wherein the apparatus is designed to subdivide the 3D socket/stump computer model into sections, having:
a display that is designed to display the surface shape and the spatial tissue distribution in a section of the sections of the 3D socket/stump computer model;
a first selection module which allows the user to select the section of the 3D socket/stump computer model for display on the display; and
a second selection module which allows the user to select at least one predetermined spatial distribution of a modification of the surface shape in the section; and
wherein the apparatus is designed to modify the surface shape in the section corresponding to the at least one predetermined spatial distribution.

2. The apparatus according to claim 1, wherein the apparatus is designed to allow the user to specify a stump axis based on the 3D socket/stump computer model, and is designed to subdivide the 3D socket/stump computer model into sections which are aligned with the stump axis.

3. The apparatus according to claim 2, wherein the sections are slices lying substantially perpendicular to the stump axis, and the apparatus is designed to allow the user to individually determine a thicknesses of a slice.

4. The apparatus according to claim 1, wherein the at least one predetermined spatial distribution comprises a subdivision of the sections into at least one subsection, wherein each subsection is assigned at least one value on which an extent of the modification of the surface shape is based.

5. The apparatus according to claim 4, which is designed such that a volume change of one of a tissue type of a plurality of tissue types contained in the at least one subsection is derived based on the at least one value and the spatial tissue distribution in the at least one subsection, and the extent of the modification of the surface shape is determined based on the volume change.

6. The apparatus according to claim 5, wherein the plurality of tissue types comprise fat, muscle, skin and/or bones, and the at least one value indicates a percent volume change of a respective tissue type, and is based on compressibility of the respective tissue type.

7. The apparatus according to claim 4, in which the second selection module allows the user to manually change the value.

8. The apparatus according to claim 4, wherein the at least one subsection is an angular sector that is disposed radially outward from a stump axis.

9. The apparatus according to claim 8, in which the second selection module allows the user to manually change a spatial alignment of the angular sector by rotation about the stump axis.

10. The apparatus according to claim 4, designed so that during the modification, the surface shape of the at least one subsection forming an outer surface of the 3D socket/stump computer model is essentially preserved.

11. The apparatus according to claim 1, in which the second selection module is designed so that predetermined spatial distributions from which the user can select for the section depend on at least one of:
a position of the section within the stump;
the spatial tissue distribution of the section; and
physiological or anatomical properties of the stump and of a patient having the stump.

12. The apparatus according to claim 1, which also comprises a database module in which predetermined spatial distributions are stored, and the apparatus is designed to adapt the predetermined spatial distributions in the database based on an analysis of preceding modifications of the 3D socket/stump computer model at least one of other patients and a patient having the stump.

13. The apparatus according to claim 1, in which the second selection module is designed so that previously determined spatial distributions from which the user can select for the section take into account an expected physiological change of the stump.

14. A method for interaction of a user with a 3D socket/stump computer model for modifying the 3D socket/stump computer model that describes a surface shape and spatial tissue distribution of a stump, comprising the following steps:
a) subdividing the 3D socket/stump computer model into sections;
b) selecting a section of the sections of the 3D socket/stump computer model for display on a display;
c) displaying the surface shape and the spatial tissue distribution of the section on the display;
d) selecting at least one predetermined spatial distribution of a modification of the surface shape in the section; and
e) modifying the surface shape in the section corresponding to at least one predetermined spatial distribution.

15. The method according to claim 14, in which a stump axis is specified based on the 3D socket/stump computer model, and the sections are aligned with the stump axis.

16. The method according to claim 15, in which the at least one predetermined spatial distribution comprises a subdivision of the section into at least one angular sector, which is disposed radially outward from the stump axis, wherein each angular sector is assigned at least one value on which an extent of the modification is based.

17. The method according to claim 16, in which a spatial alignment of the at least one angular sector is manually changed by the user by rotation about the stump axis.

18. The method according to claim 16, in which the at least one value can be changed manually by the user.

19. The method according to claim 14, in which the modification substantially retains the surface shape of a subsection of the sections forming an outer surface of the 3D socket/stump computer model.

20. A computer program which is customized to execute the method according to claim 14.

21. A system for the interaction of a user with a 3D socket/stump computer model to modify the 3D socket/stump computer model, wherein the system comprises:
a) a reading unit for reading 3D image data of the stump;
b) a segmentation unit for segmenting the 3D image data to create segmented 3D image data and determine a spatial tissue distribution of the stump;
c) a reconstruction unit for reconstructing the 3D socket/stump computer model based on the segmented 3D image data which describes a surface shape and spatial tissue distribution of the stump;
d) an apparatus for interaction with the user according to claim 1, which modifies the 3D socket/stump computer model taking into account input of the user create a modified 3D socket/stump computer model; and
e) an output unit which outputs the modified 3D socket/stump computer model to be further used in production of a prosthesis socket.

22. A method for creating a 3D socket/stump model; for producing a prosthesis socket for connecting a body part forming a stump to a prosthesis, comprising the steps:
a) acquiring 3D image data of the body part forming the stump that comprises multiple tissue types;
b) segmenting the 3D image data to create segmented 3D image data and for determining a distribution of at least one tissue type of the multiple tissue types;
c) reconstructing the 3D socket/stump model based on the segmented 3D image data, which describes a geometry of the stump and the distribution of the at least one tissue type of the multiple tissue types;
d) specifying at least one stump axis based on the 3D socket/stump model);
e) subdividing at least one area of the 3D socket/stump model into at least one slice of a specific thickness perpendicular to the at least one stump axis;
f) subdividing the at least one slice into angular sectors; and
g) modifying the 3D socket/stump model to create a modified 3D socket/stump model based on knowledge-based rule sets which are used on the angular sector sectors of the at least one slice to optimally adapt the 3D socket/stump model to the stump, wherein the knowledge-based rule sets;
take into account information contained in at least one of the 3D socket/stump model about the geometry of the stump and the distribution of the at least one tissue type, and
comprise one or more rules, which use one or more properties of the at least one tissue type.

23. The method according to claim 22, wherein a thickness of the at least one slice is specified to be larger in a proximal area than in a distal area.

24. The method according to claim 22, wherein the angular sectors comprise angle portions that are smaller medially than laterally.

25. The method according to claim 22, wherein subdividing the at least one slice into the angular sectors is performed by a user based on a selection of at least one previously specified angular sector subdivision.

26. The method according to claim 25, wherein the at least one previously specified angular sector subdivision, from which the user can select for the at least one slice, depends on at least one of:
a position of the at least one slice within the stump;
a tissue distribution in the at least one slice; and
physiological or anatomical properties of the stump and of a patient haying the stump.

27. The method according to claim 25, wherein the at least one previously specified angular sector subdivision, from which the user can select for the at least one slice, take into account an expected physiological change of the stump.

28. The method according to claim 25, wherein the at least one previously specified angular sector subdivision is adapted based on an analysis of preceding modifications of the 3D socket/stump model of at least one of other patients and a patient having the stump.

29. The method according to claim 25, wherein a selected angular sector subdivision can be rotated about the at least one stump axis by the user.

30. The method according to claim 22, wherein modifying the 3D socket/stump model comprises a volume compression, wherein the knowledge-based rule sets comprise at least one factor for the volume compression which is a percent compression value for one of the multiple tissue types contained in the angular sectors.

31. The method according to claim 30, in which the at least one factor can be changed manually by a user.

32. The method according to claim 22, in which the multiple tissue types comprise skin, fat, muscles and bones.

33. The method according to claim 22, in which, while acquiring the 3D image data of the body part forming the stump, a liner is applied for shaping the stump, wherein a material of the liner is selected so that the liner is suited for the step of segmenting the 3D image data.

34. The method according to claim 22, wherein the step of segmenting the 3D image data is performed based on 2D representations of the 3D image data.

35. The method according to claim 22, in which the knowledge-based rule sets comprise medical empirical values in a form of at least one mathematical transformation rule for modifying the 3D socket/stump model.

36. The method according to claim 22, in which the step of modifying the 3D socket/stump model based on knowledge-based rule sets comprises at least one of a modification based on an outer shape of the 3D socket/stump model and a modification for optimally adapting the 3D socket/stump model to essential bone structures.

37. The method according to claim 22, wherein the step of modifying the 3D socket/stump model takes into account a volume change running substantially parallel to the at least one stump axis based on knowledge-based rule sets of the 3D socket/stump model.

38. The method according to claim 22, wherein during the step of modifying the 3D socket/stump model, a surface smoothing of the modified 3D socket/stump model is performed, wherein the surface smoothing occurs between two adjacent slices.

39. A system for creating a 3D socket/stump model for producing a prosthesis socket for connecting a body part forming a stump to a prosthesis, comprising:
a) a recording unit for acquiring 3D image data of the body part forming the stump that comprises a plurality of tissue types;
b) a segmentation unit for segmenting the 3D image data to create segmented 3D image data and determine a distribution of at least one tissue type of the plurality of tissue types of the stump;
c) a reconstruction unit for reconstructing the 3D socket/stump model based on the segmented 3D image data from the segmentation unit, which describes a geometry of the stump and the distribution of the at least one tissue type;
d) a specification unit for specifying at least one stump axis based on the 3D socket/stump model;
e) a subdivision unit for subdividing at least one area of the 3D socket/stump model into at least one slice of a specific thickness perpendicular to the at least one stump axis and for subdividing the at least one slice into at least one angular sector; and
f) a modification unit for modifying the 3D socket/stump model based on knowledge-based rule sets which are applied to the at least one angular sector of the at least one slice, for optimally adapting the 3D socket/stump model to the stump, wherein the knowledge-based rule sets:
take into account information contained in the 3D socket/stump model about at least one of the geometry of the stump and the distribution of the at least one tissue type, and
comprise at least one rule which uses at least one property of the at least one tissue type.
